(19) United States
(12) Patent Application Publication
(10) Pub. No.: US 2005/0057141 A1
(43) Pub. Date: Mar. 17, 2005

(54) Color cathode ray tube

(76) Inventors: Sang Yoon Park, Gumi-si (KR); Jong Eon Choi, Gumi-si (KR); Pyeong Soo Jeong, Daegukwangyeok-si (KR)

Correspondence Address: BIRCH STEWART KOLASCH & BIRCH, PO BOX 747, FALLS CHURCH, VA, 22040-0747, US

(21) Appl. No.: 10/845,099

(22) Filed: May 14, 2004

(30) Foreign Application Priority Data
Sep. 17, 2003 (KR) 10-2003-0064597
Nov. 20, 2003 (KR) 10-2003-0082793

(51) Int. Cl. H01J 29/80

(52) U.S. Cl. 313/407

(57) ABSTRACT

The present invention relates to a color cathode ray tube and more specifically to a color cathode ray tube in which beam landing errors caused by doming phenomenon are corrected such that color purity is improved. A color cathode ray tube in accordance with the present invention comprises a panel on inner surface of which a phosphor screen is formed; a funnel joined to the panel; an electron gun generating electron beams; a shadow mask mounted to the panel, the shadow mask having a faceplate portion and a peripheral skirt portion bent back from the faceplate portion; and a frame having at least a welding bead, a portion of the welding bead being joined to said skirt portion, wherein depth of the welding bead is in the range of 0.5 mm to 30 mm.

### TECHNICAL FIELD

The present invention relates to a color cathode ray tube and more specifically to a color cathode ray tube in which beam landing errors caused by doming phenomenon are corrected such that color purity is improved.

### BACKGROUND OF THE INVENTION

FIG. 1 shows a schematic diagram illustrating the structure of a general color cathode ray tube. As shown in FIG. 1, the color cathode ray tube generally includes a glass envelope having a shape of bulb and being comprised of a faceplate panel 100, a tubular neck, and a funnel 105 connecting the panel 100 and the neck.

A multi-apertured color selection electrode, i.e., shadow mask 110 is mounted to the panel 100. The shadow mask 110 is hold by a peripheral frame 115. An electron gun 120 is mounted within the neck to generate and direct electron beams 125 along paths through the mask to the panel 100.

The panel 100 comprises faceplate portion and peripheral sidewall portion sealed to the funnel 105. A phosphor screen is formed on the inner surface of the faceplate portion. The phosphor screen is coated by phosphor materials of R, G, and B. Additionally, Al coating is deposited on the phosphor screen to enhance the fluorescence of the screen.

The funnel 105 is combined with the panel 100 such that the inner space of the envelope is maintained to high pressure. Within the funnel 105, electron beam 125 path is formed.

The shadow mask 110 selects electron beams of R, G, and B to direct the electron beams to respective phosphor materials on the screen. High voltage is applied to the shadow mask 110 to control the speed of the electron beams. The shadow mask 110 is made of AK material or Invar material.

The frame 115 supports the shadow mask 110. On the inner or outer side of the frame 115, an inner shield 130 for shielding the cathode ray tube from outer terrestrial magnetism is welded to the frame 115.

The electron gun 120 forms electron beams by heating cathode to generate electrons and accelerating and gathering the electrons.

The operation of the general cathode ray tube will be described shortly. The electron beams 125, which are radiated from the electron gun 120, impinge upon the surface of the shadow mask 110.

Among the electrons 125 impinging on the shadow mask 110, those which pass through the apertures of the shadow mask 110 and reach to the phosphor screen amount 20% of the overall electrons. The rests collide with the shadow mask 110 generating heat energy.

With the collision of the electrons, surface temperature of the shadow mask 110 rises to 80˜90° C. Then, the shadow mask 110 is thermally expanded and, therefore, position of the apertures at the shadow mask is shifted from the desired position. Therefore, electron beams passing through the apertures land at the screen incorrectly. In this way the color purity at the screen is degraded. This phenomenon of purity degradation resulting from the undesired positional shift of the apertures of the mask is called the “doming effect”.

FIG. 2 shows a perspective view of a quarter of a shadow mask illustrating thermal distribution of the surface of the mask due to the impingement of electrons. As shown in FIG. 2, temperature of the mask is different for different portion of the mask. In FIG. 2, center portion of the mask has higher temperature than corner portion. The reason why the corner portion has lower temperature is that the heat at the corner portion is dissipated through the frame attached to the mask. Since the frame is attached to the mask at the skirt portion near the corner, heat at the corner is easily transferred to outside via the frame.

FIG. 3 shows a sectional view of the mask-frame assembly for illustrating thermal expansion of the mask. As shown in FIG. 3, the skirt portion 301 of the shadow mask 110 is welded to the welding bead 302 of the frame 115. The heat at the shadow mask 110 transfers to the frame 115 directly through the skirt portion 301. Also, the heat radiated from the skirt portion to the frame 115. As the heat transfer and radiation increases, thermal difference between the central and corner portion of the shadow mask increases.

As the thermal difference between the central and the corner portion of the shadow mask 110 increases, landing error of the electron beams increases accordingly.

In FIG. 3, 110 represents the shadow mask before thermal expansion. Dotted line 111 represents the shadow mask which is thermally expanded. As shown in FIG. 3, since the shadow mask 110 contacts with the frame 115, the frame 115 disturbs expansion of the shadow mask 110. Moreover, as the shadow mask 110 expands, the shadow mask 110 interferes with the frame 115. Accordingly, landing error problem becomes worse because of the interference between the shadow mask 110 and the frame 115.

### SUMMARY OF THE INVENTION

An object of the present invention is to provide a color cathode ray tube where landing error problem causing degradation of color purity is prevented.

Another object of the present invention is to provide a color cathode ray tube where non-uniform thermal expansion of the shadow mask is reduced such that color purity is improved.

Further object of the present invention is to provide a color cathode ray tube where the influence of the welding point between the shadow mask and frame on thermal expansion of the shadow mask is minimized such that color purity is improved.

According to an aspect of the present invention, a color cathode ray tube comprises a panel on inner surface of which a phosphor screen is formed; a funnel joined to the panel; an electron gun generating electron beams; a shadow mask mounted to the panel, the shadow mask having a faceplate portion and a peripheral skirt portion bent back from the faceplate portion; and a frame having at least a welding bead, a portion of the welding bead being joined to said skirt portion, wherein depth of the welding bead is in the range of 0.5 mm to 30 mm.

According to another aspect of the present invention, a color cathode ray tube comprises a panel on inner surface of which a phosphor screen is formed; a funnel joined to the panel; an electron gun generating electron beams; a shadow mask mounted to the panel, the shadow mask having a faceplate portion and a peripheral skirt portion bent back from the faceplate portion; and a frame joined to said skirt portion, wherein said skirt portion has a protrusion which protrudes toward said frame and a portion of the protrusion is joined to said frame.

According to other aspect of the present invention, a color cathode ray tube comprises a panel on inner surface of which a phosphor screen is formed; a funnel joined to the panel; an electron gun generating electron beams; a shadow mask mounted to the panel, the shadow mask having a faceplate portion and a peripheral skirt portion bent back from the faceplate portion; and a frame having at least a welding bead, a portion of the welding bead being joined to said skirt portion, wherein distance between said skirt portion and said frame is in the range of 0.5 mm to 30 mm.

### BRIEF DESCRIPTION OF THE DRAWINGS

FIG. 1 shows a schematic diagram illustrating the structure of a general color cathode ray tube.

FIG. 2 shows a perspective view of a quarter of a shadow mask illustrating thermal distribution of the surface of the mask due to the impingement of electrons.

FIG. 3 shows a sectional view of the mask-frame assembly for illustrating thermal expansion of the mask.

FIG. 4 shows a planar sectional view of the frame in accordance with Embodiment 1 of the present invention.

FIG. 5 shows a sectional view of the mask-frame assembly for illustrating thermal expansion of the mask in accordance with the present invention.

FIGS. 6 and 7 show a table and a graph of amount of landing errors of shadow masks having welding beads of different depths in accordance with the present invention.

FIGS. 8 and 9 show a table and a graph of amount of landing errors of a shadow masks having welding beads of different depths in accordance with the modified version of Embodiment 1.

FIG. 10 shows a sectional view of a mask frame assembly according to Embodiment 2 of the present invention.

FIGS. 11 and 12 show a table and a graph of amount of landing errors of shadow masks where skirt portions have projections of different lengths in accordance with Embodiment 2.

FIG. 13 shows a sectional view of a mask frame assembly according to Embodiment 3 of the present invention.

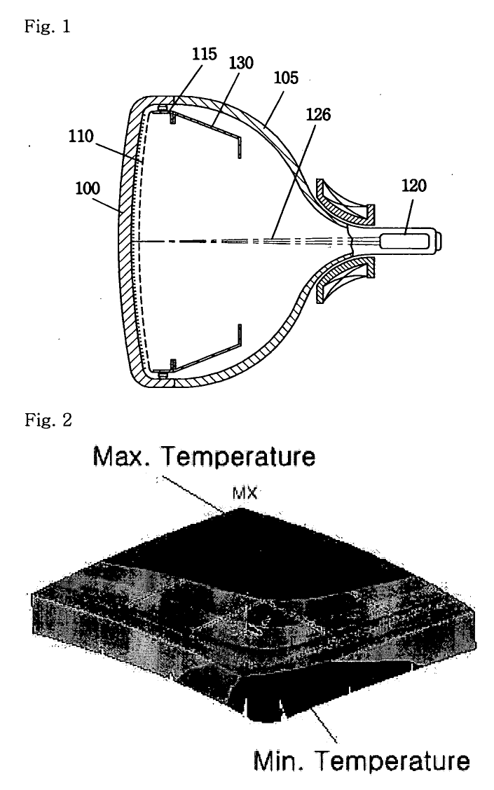

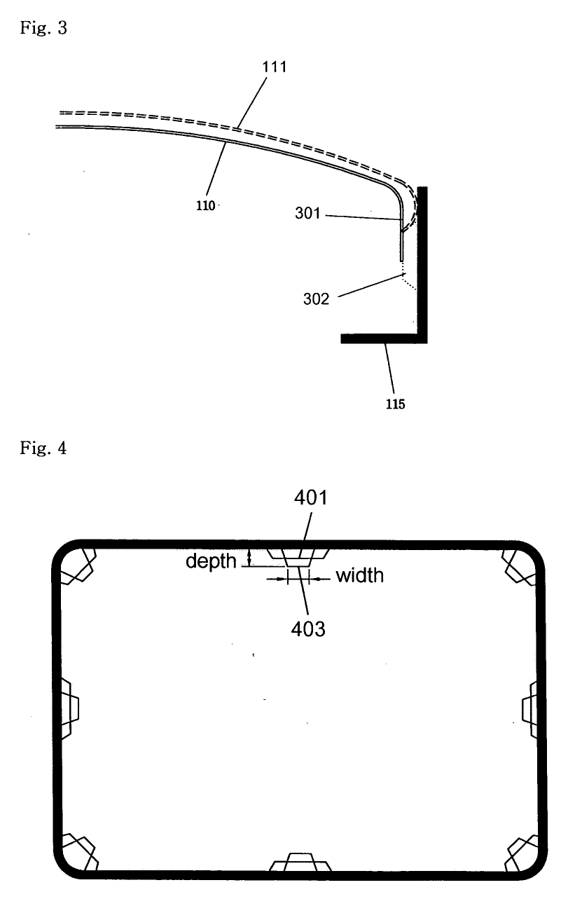

### DETAILED DESCRIPTION

Preferred embodiments of the present invention will be described in a more detailed manner with reference to the drawings.

### EMBODIMENT 1

According to an aspect of the present invention, a color cathode ray tube comprises a panel on inner surface of which a phosphor screen is formed; a funnel joined to the panel; an electron gun generating electron beams; a shadow mask mounted to the panel, the shadow mask having a faceplate portion and a peripheral skirt portion bent back from the faceplate portion; and a frame having at least a welding bead, a portion of the welding bead being joined to said skirt portion, wherein depth of the welding bead is in the range of 0.5 mm to 30 mm.

FIG. 4 shows a planar sectional view of the frame in accordance with Embodiment 1 of the present invention.

As shown in FIG. 4, the frame 115 has at least a welding bead 403 protruding toward the skirt portion. Depth of the welding beads 403 of the present invention are in the range of 0.5 mm to 30 mm. At least a portion of the welding bead is joined to the skirt portion by, e.g., welding. The depths of the welding beads 403 are large in comparison with the conventional welding beads 401. By making the welding beads 403 relatively large, it is possible to reduce interference between the shadow mask and the frame during the thermal expansion of the shadow mask. Since, distance between the skirt portion and the frame becomes large, heat transfer from the skirt portion to the frame also decreases. Accordingly, non-uniformity of thermal expansion between central and corner portions of the shadow mask is reduced and, thereby, landing errors are also reduced.

Preferably, the depth of the welding beads 403 may be in the range of 3 mm to 20 mm. By making the welding beads 403 as deep as 3 mm to 20 mm, the benefit of the present invention is achieved more effectively.

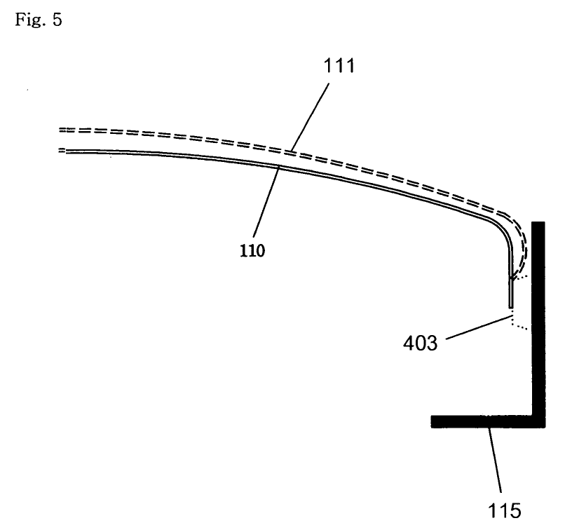

FIG. 5 shows a sectional view of the mask-frame assembly for illustrating thermal expansion of the mask in accordance with the present invention. In FIG. 5, 110 represents the shadow mask before thermal expansion. Dotted line 111 represents the shadow mask which is thermally expanded. As shown in FIG. 5, the shadow mask 111 does not contact with the frame even when it is thermally expanded. This is because the distance between the skirt portion 110 and the frame 115 increases according to the depth of the welding beads, i.e., 0.5 mm to 30 mm.

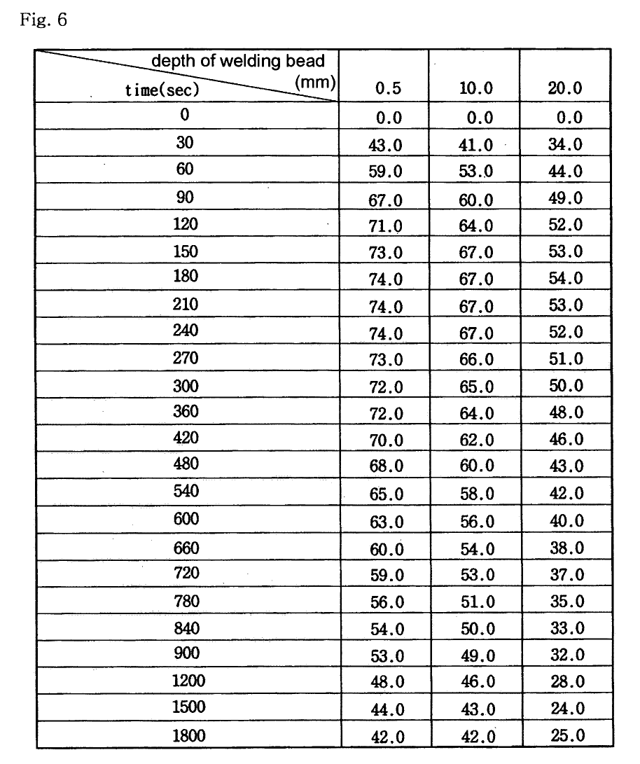

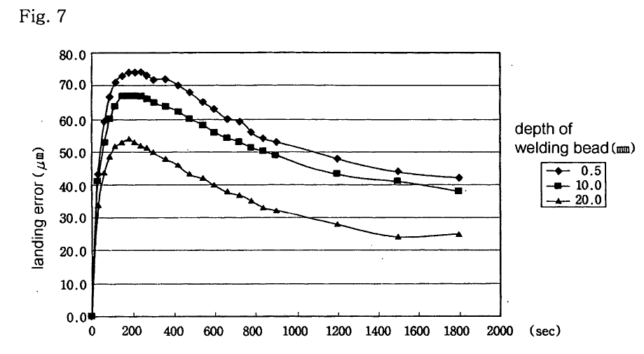

FIGS. 6 and 7 show a table and a graph of amount of landing errors of shadow masks having welding beads of different depths in accordance with the present invention.

As shown in FIGS. 6 and 7, when depths of welding beads are 0.5 mm, 10 mm, and 20 mm, landing error is reduced as the depth increases. According to Embodiment 1 of the present invention, when depths of the welding beads are in the range of 0.5 mm to 30 mm, landing error is effectively reduced.

According to a modified version of Embodiment 1, widths of the welding beads are in the range of 5 mm to 50 mm, while depths are in the range of 0.5 mm to 30 mm. By narrowing the widths, the area of the skirt portion which contacts with the welding beads is reduced. Therefore, heat transfer is also reduced. In this way, landing errors due to non-uniform thermal expansion are reduced more effectively.

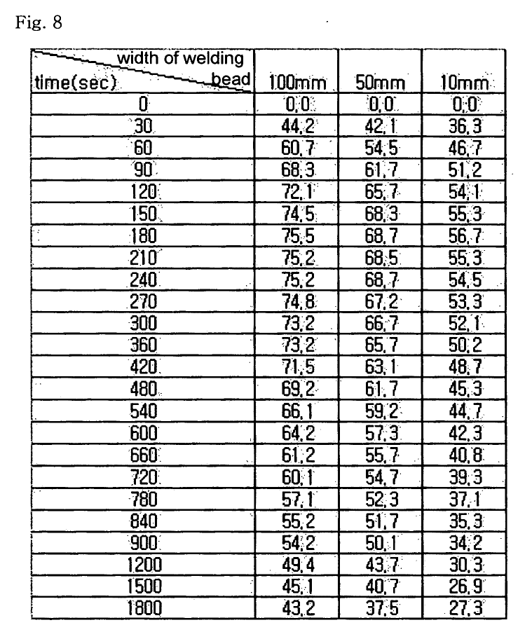

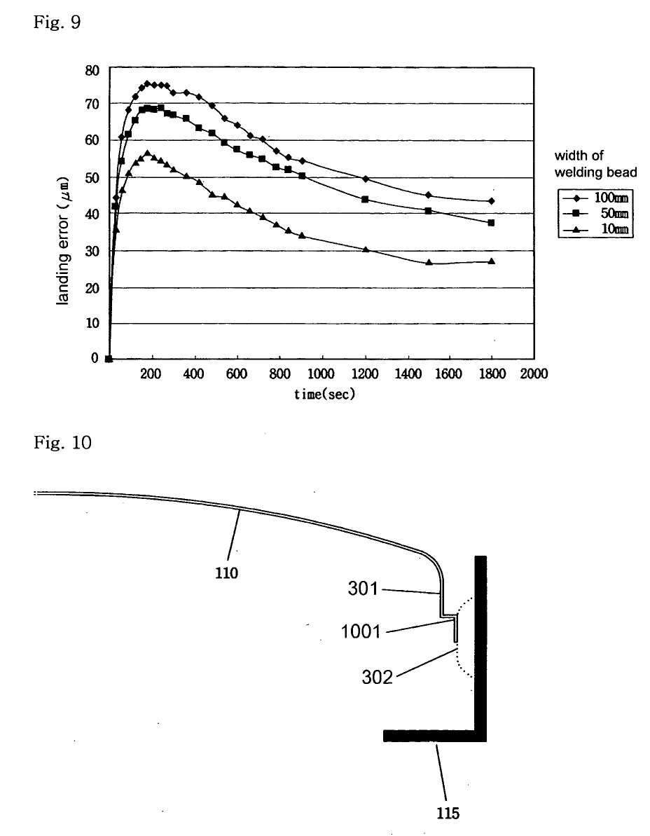

FIGS. 8 and 9 show a table and a graph of amount of landing errors of a shadow masks having welding beads of different depths in accordance with the modified version of Embodiment 1.

As shown in FIGS. 8 and 9, when widths of welding beads are 100 mm, 50 mm, and 10 mm, landing error is reduced as the width decreases. According to a modified version of Embodiment 1 of the present invention, when widths of the welding beads are in the range of 5 mm to 50 mm, landing error is effectively reduced.

Preferably, in addition to making the depth of the welding beads 403 to be in the range of 3 mm to 20 mm, the width of the welding beads is made to be in the range of 5 mm to 50 mm. In this manner, the benefit of the present invention is achieved more effectively because the width is relatively large in comparison with the prior art.

As another modified version of Embodiment 1, depths of the welding beads are made to be in the range of 0.5 mm to 30 mm and, additionally, projections are provided at parts of the skirt portion to which the welding beads are joined. By providing the projections at the skirt portion side, the distance between the skirt portion and the frame becomes larger. Accordingly, the benefit of the present invention, i.e., preventing interference between the skirt portion and the frame and reducing landing errors, is achieved more effectively. Detailed description on the projections at the skirt portion is mentioned later in the specification regarding Embodiment 2 of the invention.

According to a modified version of Embodiment 1 of the present invention, in addition to the welding beads at the frame 115, a protrusion is formed at the skirt portion 301 such that distance between the skirt portion 301 and the frame 115 is in the range of 0.5 mm to 30 mm. Accordingly, landing errors due to non-uniform thermal expansion is reduced and interference between the skirt portion 301 and the frame 115 is prevented.

Additionally, holes may be perforated at the skirt portion such that area of the part in the skirt portion which is opposite to the frame is further reduced. Accordingly, amount of the landing error is further diminished.

Additionally, a portion of said skirt portion is opposite to said frame, and height of the portion opposite to said frame may be 10 mm or below such that area of that portion is further reduced. Accordingly, amount of the landing error is further diminished.

Additionally, the skirt portion may have an extension having welding point to be welded to the frame. The extension is extended from the end line of the skirt portion. With the extension, it is possible to further reduce length of the portion in the skirt portion which is opposite to the frame. Moreover, it is possible to prevent the welding points from becoming a binding when the mask expands. Therefore, landing error problem is reduced further.

For the every embodiment described hereinabove, even when AK material is used for the shadow mask, landing error is still remarkably reduced in comparison with the prior art.

Further, any electron beam reflecting material may be coated on the surface of the shadow mask upon which electron beams are incident. With the reflecting material, heat generation due to impinge of electron beams is reduced. Therefore, temperature elevation of the shadow mask is reduced and, accordingly, landing error is further reduced.

Further, the every embodiment described hereinabove may be applied to a flat type color cathode ray tube where outer surface of panel is substantially flat. The outer surface of panel means the surface which is shown to a viewer. Therefore, the effect of the present invention is still effective for a flat type color cathode ray tube.

### EMBODIMENT 2

According to another aspect of the present invention, a color cathode ray tube comprises a panel on inner surface of which a phosphor screen is formed; a funnel joined to the panel; an electron gun generating electron beams; a shadow mask mounted to the panel, the shadow mask having a faceplate portion and a peripheral skirt portion bent back from the faceplate portion; and a frame joined to said skirt portion, wherein said skirt portion has a protrusion which protrudes toward said frame and a portion of the protrusion is joined to said frame.

FIG. 10 shows a sectional view of a mask frame assembly according to Embodiment 2 of the present invention. According to Embodiment 2, the skirt portion has at least a protrusion 1001 which protrudes toward the frame 115. At least a portion of the protrusion 1001 is joined to the welding beads 302 of the frame 115 by, e.g., welding. Since the skirt portion 301 is joined to the welding beads 302 through the protrusion 1001, the skirt portion 301 becomes more far from the frame 115. Accordingly, heat transfer from the skirt portion 301 to the frame 115 is diminished and, thereby, thermal difference between the central and corner portions of the shadow mask is also diminished. Further, interference between the skirt portion 301 and the frame 115 is prevented.

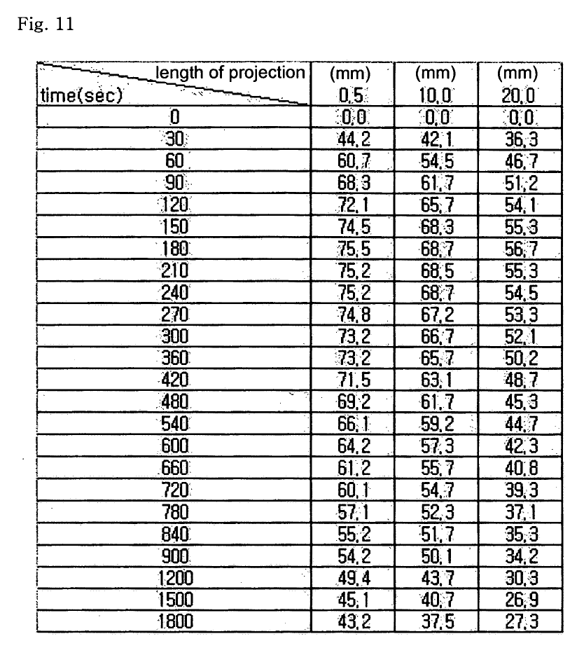

FIGS. 11 and 12 show a table and a graph of amount of landing errors of shadow masks where skirt portions have protrusions of different lengths in accordance with Embodiment 2.

As shown in FIGS. 11 and 12, when lengths of protrusions are 0.5 mm, 10 mm, and 20 mm, landing error is reduced as the length increases. By providing protrusions 1001 at the skirt portion 301, distance between the skirt portion 301 and the frame 115 becomes larger. Accordingly, heat transfer from the skirt portion 301 to the frame 115 is diminished and, thereby, thermal difference between the central and corner portions of the shadow mask is also diminished. Further, interference between the skirt portion 301 and the frame 115 is prevented.

Preferably, the protruding length of the protrusions is no smaller than 0.5 mm. In this way, the landing error is reduced and the interference between the skirt portion and the frame is prevented more advantageously.

According to a modified version of Embodiment 2 of the present invention, welding beads are formed at the frame 115 such that the welding beads are protruded toward the skirt portion 301. In this manner, it is possible to make distance between the skirt portion 301 and the frame 115 be in the range of 0.5 mm to 30 mm. Accordingly, landing errors due to non-uniform thermal expansion is reduced and interference between the skirt portion 301 and the frame 115 is prevented.

As a further modified version of Embodiment 2, a protrusion is provided to the protrusion 1001 of the skirt portion 301 such that the distance between the skirt portion 301 and the frame 115 becomes in the range of 0.5 mm to 30 mm. In this manner, the above-mentioned benefit of the present invention can still be achieved.

For Embodiment 2, the modifications made to Embodiment 1 as described above may also be applied. Such modifications includes: providing holes at the skirt portion; limiting height of the portion of the skirt portion which is opposite to the frame; and providing extensions at the skirt portion. Detailed description of such modifications should be referred to that of Embodiment 1.

Embodiment 2 may further include such modifications as the use of AK material for the shadow mask; coating electron beams reflecting material on the surface of the shadow mask upon which the electron beams are incident; and making the outer surface of panel to be substantially flat.

### EMBODIMENT 3

According to other aspect of the present invention, a color cathode ray tube comprises a panel on inner surface of which a phosphor screen is formed; a funnel joined to the panel; an electron gun generating electron beams; a shadow mask mounted to the panel, the shadow mask having a faceplate portion and a peripheral skirt portion bent back from the faceplate portion; and a frame having at least a welding bead, a portion of the welding bead being joined to said skirt portion, wherein distance between said skirt portion and said frame is in the range of 0.5 mm to 30 mm.

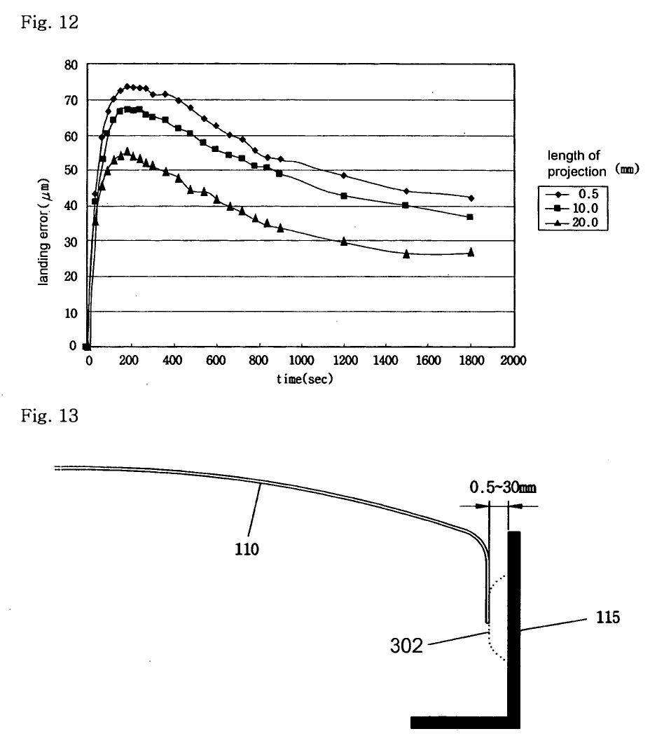

FIG. 13 shows a sectional view of a mask frame assembly according to Embodiment 3 of the present invention. According to Embodiment 3, distance between the skirt portion 301 and the frame 115 is made to be in the range of 0.5 mm to 30 mm by providing welding bead at the frame 115. In this way, the skirt portion 301 becomes more far from the frame 115 in comparison with the prior art. Accordingly, heat transfer from the skirt portion 301 to the frame 115 is diminished and, thereby, thermal difference between the central and corner portions of the shadow mask is also diminished. Further, interference between the skirt portion 301 and the frame 115 is prevented.

For Embodiment 3, the modifications made to Embodiment 1 as described above may also be applied. Such modifications includes: providing holes at the skirt portion; limiting height of the portion of the skirt portion which is opposite to the frame; and providing extensions at the skirt portion. Detailed description of such modifications should be referred to that of Embodiment 1.

Embodiment 3 may further include such modifications as the use of AK material for the shadow mask; coating an electron beam reflecting material on the surface of the shadow mask upon which the electron beams are incident; and making the outer surface of panel to be substantially flat.

### INDUSTRIAL APPLICABILITY

As described hereinabove, according to the present invention, it is possible to reduce area through which the shadow mask and the frame contact and increase distance between the skirt portion and the frame. Accordingly, temperature difference between central and corner portions of the shadow mask is reduced. In this manner, the present invention accomplishes the effect that landing error of electron beam, which is caused by non-uniform thermal expansion of the shadow mask, is reduced.

Further, according to the present invention, AK material may be used instead of invar material. Since AK material is not expensive in comparison with invar material, overall cost for making a shadow mask is reduced.

1. A color cathode ray tube comprising:
a panel on inner surface of which a phosphor screen is formed;
a funnel joined to the panel;
an electron gun generating electron beams;
a shadow mask mounted to the panel, the shadow mask having a faceplate portion and a peripheral skirt portion bent back from the faceplate portion; and
a frame having at least a welding bead, a portion of the welding bead being joined to said skirt portion, wherein
depth of the welding bead is in the range of 0.5 mm to 30 mm.

2. The color cathode ray tube of claim 1, wherein
depth of the welding bead is in the range of 3 mm to 20 mm.

3. The color cathode ray tube of claim 1, wherein
width of the welding bead is in the range of 5 mm to 50 mm.

4. The color cathode ray tube of claim 2, wherein
width of the welding bead is in the range of 5 mm to 50 mm.

5. The color cathode ray tube of claim 1, wherein
surface of said shadow mask upon which the electron beams are incident is coated by an electron beam reflecting material.

6. The color cathode ray tube of claim 1, wherein
said shadow mask is made of AK material.

7. The color cathode ray tube of claim 1, wherein
outer surface of said panel is substantially flat.

8. The color cathode ray tube of claim 1, wherein
said skirt portion has a protrusion, and
a portion of the protrusion is joined to said frame.

9. The color cathode ray tube of claim 1, wherein
distance between said skirt portion and said frame is in the range of 0.5 mm to 30 mm.

10. The color cathode ray tube of claim 8, wherein
distance between said skirt portion and said frame is in the range of 0.5 mm to 30 mm.

11. The color cathode ray tube of claim 1, wherein
a plurality of holes are perforated at said skirt portion.

12. The color cathode ray tube of claim 1, wherein
a portion of said skirt portion is opposite to said frame, and height of the portion opposite to said frame is 10 mm or below.

13. The color cathode ray tube of claim 1, wherein
said skirt portion comprises an extension having a welding point to be welded to said frame.

14. A color cathode ray tube comprising:
a panel on inner surface of which a phosphor screen is formed;
a funnel joined to the panel;
an electron gun generating electron beams;
a shadow mask mounted to the panel, the shadow mask having a faceplate portion and a peripheral skirt portion bent back from the faceplate portion; and
a frame joined to said skirt portion, wherein
said skirt portion has a protrusion which protrudes toward said frame and a portion of the protrusion is joined to said frame.

15. The color cathode ray tube of claim 14, wherein
protruding length of the protrusion is no smaller than 0.5 mm.

16. The color cathode ray tube of claim 14, wherein surface of said shadow mask upon which the electron beams are incident is coated by an electron beam reflecting material.

17. The color cathode ray tube of claim 14, wherein said shadow mask is made of AK material.

18. The color cathode ray tube of claim 14, wherein outer surface of said panel is substantially flat.

19. The color cathode ray tube of claim 14, wherein
said frame has at least a welding bead,
a portion of the welding bead is joined to said skirt portion, and distance between said skirt portion and said frame is in the range of 0.5 mm to 30 mm.

20. The color cathode ray tube of claim 14, wherein
distance between said skirt portion and said frame is in the range of 0.5 mm to 30 mm.

21. The color cathode ray tube of claim 14, wherein
a plurality of holes are perforated at said skirt portion.

22. The color cathode ray tube of claim 14, wherein
a portion of said skirt portion is opposite to said frame, and
height of the portion opposite to said frame is 10 mm or below.

23. The color cathode ray tube of claim 14, wherein said skirt portion comprises an extension having a welding point to be welded to said frame.

24. A color cathode ray tube comprising:
a panel on inner surface of which a phosphor screen is formed;
a funnel joined to the panel;
an electron gun generating electron beams;
a shadow mask mounted to the panel, the shadow mask having a faceplate portion and a peripheral skirt portion bent back from the faceplate portion; and
a frame having at least a welding bead, a portion of the welding bead being joined to said skirt portion, wherein
distance between said skirt portion and said frame is in the range of 0.5 mm to 30 mm.

25. The color cathode ray tube of claim 24, wherein
surface of said shadow mask upon which the electron beams are incident is coated by an electron beam reflecting material.

26. The color cathode ray tube of claim 24, wherein
said shadow mask is made of AK material.

27. The color cathode ray tube of claim 24, wherein
outer surface of said panel is substantially flat.

28. The color cathode ray tube of claim 24, wherein
a plurality of holes are perforated at said skirt portion.

29. The color cathode ray tube of claim 24, wherein
a portion of said skirt portion is opposite to said frame, and
height of the portion opposite to said frame is 10 mm or below.

30. The color cathode ray tube of claim 24, wherein
said skirt portion comprises an extension having a welding point to be welded to said frame.
